(19) United States
(12) Patent Application Publication
(10) Pub. No.: US 2026/0288749 A1
(43) Pub. Date: Sep. 24, 2026

(54) System And Method For Responsively Optimizing Usability For A User Across A Range Of Usability Needs

(71) Applicant: eightplus LLC, SACRAMENTO, CA (US)

(72) Inventor: Janesh Ramakrishnan, Sacramento, CA (US)

(21) Appl. No.: 19/443,094

(22) Filed: Jan. 8, 2026

Related U.S. Application Data
(60) Provisional application No. 63/776,193, filed on Mar. 23, 2025.

(51) Int. Cl. G06F 16/25

(52) U.S. Cl. CPC G06F 16/258

(57) ABSTRACT

The present disclosure relates to a system and method for responsively optimizing usability for a user across a range of usability needs. The system comprises an input interface, a processor, a storage, and an output interface. The input interface captures user signals, behavioral indicators, sensor data, data originating from learning/education platforms, or service provider data from an online or offline environment. The processor deploys a schema transformation engine that utilizes one or more artificial intelligence (AI) agents or large language models (LLMs) to transform captured unstructured or semi-structured data into structured data based on a schema. The schema transformation engine provides a standardized format suitable for downstream processing and to generate a usability profile. The storage maintains and responsively updates the usability profile and metadata. The output interface for presenting a derived output. The system and method automatically convert diverse, unstructured, semi-structured data, or unusable inputs, into standardized, usable outputs using AI, thereby enabling usability and scalable downstream processing.

### CROSS-REFERENCE TO RELATED APPLICATIONS

The present application also claims the benefit of and priority U.S. Provisional Application No. 63/776,193, all of which are hereby incorporated herein by reference in their entireties.

### DESCRIPTION

### Field of the Invention

The present invention relates to the field of usability optimization technologies, and more specifically to a system and method for responsively optimizing usability for a user across a range of usability needs. This enables accurate, dynamic detection of a user's usability profile by leveraging multi-source contextual data and adaptable computing models to enhance personalization and system performance.

### BACKGROUND

### Interpretation Considerations

This section provides a detailed description of the technical field and discusses the problems encountered within it. Therefore, statements in the section are not to be construed as prior art.

### DISCUSSION

Conventional digital systems often fail to adequately accommodate users with diverse usability needs, thereby limiting access for large segments of the population. These needs include, but are not limited to, challenges faced by individuals with hearing impairments (example, reliance on purely audio instructions), speech difficulties (example, systems demanding complex voice commands), visual impairments (example, interfaces lacking sufficient contrast or proper semantic structure), physical limitations (example, requiring rapid, complex motor inputs), cognitive differences (example, overwhelming interfaces or non-linear workflows), or language barriers (example, poor machine translation or monolingual design). A fundamental deficiency in current technology is the limited capacity within these systems to detect, interpret, and adapt their functionality in real time based on the varied, context-specific usability challenges a user is actively experiencing. This inadequacy is pervasive in both online digital interfaces (e.g., websites and mobile applications) and on-site (physical) environments that incorporate digital interfaces (e.g., self-service kiosks and smart public displays). These systemic limitations result in poor adaptability to individual user context and severely restrict inclusivity across digital platforms.

Furthermore, current digital systems are architecturally rigid, lacking the capability to dynamically transform or represent information in a way that is immediately consumable and actionable by advanced back-end processors. Specifically, the data representation generated by standard user interfaces (UIs) is often static and does not encode the user's specific access context or the nature of their interaction difficulty. This limitation prevents artificial intelligence (AI) engines or service providers from effectively and instantaneously implementing necessary changes to meet individual user requirements. Consequently, users are often unable to interact efficiently or complete critical tasks within systems that depend heavily upon static, non-modifiable interaction modalities such as audio-based instructions with no visual alternative, visually complex or dense interfaces, time-constrained rapid sequential inputs, rigidly structured voice-driven workflows, or complex multilingual content that cannot be intelligently simplified or restructured in real-time. The lack of a dynamic, context-aware information representation model is a core technical impediment to achieving pervasive and universal digital accessibility.

Another critical limitation of existing digital platforms is their inherent inability to automatically generate high-fidelity, actionable organizational insights from raw user interaction data. Service providers and organizational stakeholders, such as product managers or accessibility compliance officers, typically lack crucial granular visibility into the specific user journeys in which and how substantive usability issues arise, rather than merely cosmetic errors. The collected data is often too siloed, sparse, or aggregated to enable effective diagnosis. This deficiency prevents organizations from accurately quantifying the impact of usability challenges on key business and mission metrics, including user engagement rates, overall customer satisfaction scores, task completion rates, and business conversion rates. As a direct result, organizations routinely miss opportunities to make targeted, data-driven decisions that could significantly improve accessibility standards, product design principles, service flow optimization, and overall organizational business outcomes through effective resource allocation.

Additionally, conventional systems are structurally unable to process and transform vast amounts of unstructured, multi-source, or complex transactional data into standardized, usable formats, including user telemetry, sensor inputs, and behavioral logs. Such transformation is a necessary prerequisite for sophisticated downstream applications, including advanced analytics, the construction of personalized user profiles, and the training of highly effective AI models dedicated to accessibility and assistance. This substantial technological gap prevents various service providers, including commercial enterprises, government agencies, healthcare institutions, and nonprofit organizations, from effectively leveraging the full value of user data to tangibly and proactively enhance both overall system usability and inclusiveness.

Therefore, there is a need to develop an intelligent and adaptive system and method that can detect and dynamically update a user's usability profile based on real-time interaction data and contextual information. The system should be capable of continuously analyzing and responding to diverse usability needs by integrating and processing multi-source data, including interaction logs, contextual cues, and environmental parameters. This process generates and refines comprehensive user profiles that support real-time adaptability and personalized user experiences.

### SUMMARY

An objective of the present invention is to provide a system and method for responsively optimizing usability for a user across a range of usability needs, producing high-quality, structured data from diverse users, sensors, and provider signals, thereby enabling interoperable downstream analytics and personalization.

Another objective of the present invention is to provide a system and method for updating usability profiles that tailor outputs to cognitive load, language, and sensory access, reducing effort and improving task performance for diverse users. Multimodal outputs (text, voice, haptics) enhance robustness, user preference, and universal access relative to a unimodal interface.

Yet another objective of the present invention is to provide a system and method for proactive, intent-aware pipelines that enhance relevance and responsiveness across online/offline environments and various device form factors.

Still another objective of the present invention is to provide a system and method for continuous improvement through feedback loops, the storage of interaction history, real-time feedback, and situational adaptation, which refine the usability profile and output quality over time.

Still another objective of the present invention is to provide a large language model (LLM)-assisted extract, transform, load (ETL), and schema inference to accelerate the ingestion of unstructured or semi-structured data, while improving the accuracy and consistency of the knowledge base.

This and other objectives are achieved by providing a system and method for responsively optimizing usability for a user across a range of usability needs as defined in the features of the independent claims. Additional advantageous embodiments and improvements of the invention are listed in the dependent claims. The use of expressions like “ . . . aspect according to the invention” or “in one embodiment” or similar terminology is intended to refer to examples or embodiments consistent with the broadest scope of the invention as defined by the independent claims.

According to a first aspect, the present invention discloses a system for responsively optimizing usability for a user across a range of usability needs. The system comprises an input interface, a processor, a storage, and an output interface. The input interface captures the user signals, behavioral indicators, sensor data, data originating from learning/education platforms, or service-provider data from an online or offline environment. The processor deploys a schema transformation engine that uses one or more artificial intelligence (AI) agents or large language models (LLMs) to transform captured unstructured or semi-structured data into structured data based on a schema to provide a standardized format suitable for downstream processing and to generate a usability profile. The storage maintains and responsively updates the usability profile and metadata. The output interface presents a derived output. This system automatically converts diverse, unstructured, or semi-structured data into standardized, usable, structured formats using AI, enabling efficient and scalable downstream processing.

In an embodiment of the present invention, the input interface captures behavioral and contextual data to collect relevant user and environmental information for adaptive processing.

In another embodiment of the present invention, the schema transformation engine includes pattern recognition, schema inference, format translation, or a prompt-based conversation using LLMs or AI agents, enabling interoperability across data sources. This offer automatically converts diverse, unstructured, or semi-structured data into standardized, usable, and structured formats for efficient and scalable downstream processing.

In another embodiment of the present invention, the output interface presents the derived output as a training dataset to one or more artificial intelligence (AI) systems.

In another embodiment of the present invention, the schema transformation engine enables the system to detect, parse, and transform the captured unstructured or semi-structured data into standardized intermediate formats suitable for AI-powered processing and usability adaptation. The system ensures seamless integration of heterogeneous data, enhancing automation and system efficiency.

In yet another embodiment of the present invention, the metadata includes at least one of cognitive load, sensory access, language access, preferences, interaction history, real-time feedback, sensor inputs, historical usage patterns, environmental context, situational adaptation history, or other interaction parameters. This provides personalized and context-aware system behavior that adapts outputs and interactions to the individual user's needs and environment.

In yet another embodiment of the present invention, the usability profile includes one or more parameters derived from behavioral indicators, environmental context, declared preferences, sensor data, or historical usage patterns. This enables enhanced personalization, improved predictive accuracy, and optimized user experience.

In yet another embodiment of the present invention, the processor deploys at least one or more artificial intelligence (AI) agents or large language models (LLMs) to apply techniques selected from prompt engineering, chain-of-thought prompting, few-shot learning, retrieval-augmented generation (RAG), parameter-efficient fine-tuning (PEFT), low-rank adaptation (LoRA), or reinforcement learning from human feedback (RLHF) to reason over the standardized format and generate transformations tailored to the usability profile and universal design guidelines. This process enhances reasoning accuracy and enables context-sensitive, adaptive data transformation that is aligned with both user and system objectives.

In yet another embodiment of the present invention, the output interface employs an output personalization engine to generate the derived output. This delivers context-aware, user-specific results optimized for accessibility, engagement, and downstream system utilization.

In yet another embodiment of the present invention, the derived output includes at least one of text simplification, language translation, alternative modalities including voice or haptic interfaces, modular content presentation, markup customized per the usability profile, or any other service customized based on the usability profile. This system enables adaptive and accessible content delivery, enhancing user comprehension, inclusivity, and interaction experience across diverse user needs and contexts.

In yet another embodiment of the present invention, the system is a smartphone, an electronic device, a tablet, a kiosk, a laptop, a wearable, a voice assistant, or an embedded system.

According to a second aspect, the present invention discloses a method for responsively optimizing usability for a user across a range of usability needs. The method comprises the step of a) capturing user signals, behavioral indicators, sensor data, data originating from learning/education platforms, or service data from an online or offline environment; b) transforming the captured unstructured or semi-structured data into standardized formats based on a schema suitable for downstream processing; c) generating a usability profile for the user; d) maintaining and responsively updating the usability profile and metadata; and e) presenting a derived output using the standardized format. Further, the method enables an adaptive, intelligent, and user-centric interaction framework that delivers personalized, accessible, and contextually optimized user experiences across heterogeneous data environments, thereby improving engagement, satisfaction, and operational efficiency.

In yet another embodiment of the present invention, the method further comprises capturing behavioral and contextual data. This improves the accuracy and relevance of personalized outputs for end users.

In yet another embodiment of the present invention, transforming the captured unstructured or semi-structured data includes performing at least one of pattern recognition, schema inference, format translation, or a prompt-based conversation using large language models (LLMs) or AI agents to enable interoperability across data sources. This enhances interoperability and accelerates downstream AI processing by normalizing diverse inputs.

In yet another embodiment of the present invention, the method comprises presenting the derived output as a training dataset to one or more artificial intelligence (AI) systems. This enables strengthened model learning and broader coverage of real-world scenarios.

In still another embodiment of the present invention, the method comprises presenting the derived output as an inference dataset to one or more artificial intelligence (AI) systems. This provides improved runtime accuracy and reliability of model predictions.

In still another embodiment of the present invention, transforming the captured unstructured or semi-structured data comprises detecting, parsing, and transforming the data into standardized intermediate formats suitable for AI-powered processing and usability adaptation. This reduces integration friction and ensures consistent usability across systems.

In still another embodiment of the present invention, the usability profile includes deriving one or more parameters from behavioral indicators, environmental context, declared preferences, sensor data, or historical usage patterns. This enables enhanced personalization, improved predictive accuracy, and optimized user experience.

According to a third aspect, the present invention discloses a computer-implemented method for responsively generating a usability-adapted derived output using a structured prompt framework. The method comprises the steps of a) receiving, via an input interface, user signals, behavioral indicators, sensor data, data originating from learning/education platforms, contextual data, or service-provider data originating from an online or offline environment; b) transforming the received unstructured or semi-structured data into a standardized intermediate format using a schema transformation engine that performs pattern recognition, schema inference, format translation, or prompt-based conversion through one or more large language models (LLMs) or AI agents; c) generating and responsively updating a usability profile for the user; d) applying, by one or more processors, a prompt framework to select and configure LLMs or AI agents based on the standardized intermediate format, the usability profile, and environmental context, the prompt framework directing ordered stages comprising interpretation of the normalized data, selection of prompt-engineering techniques, and generation of structured intermediate reasoning outputs e) evaluating the structured intermediate reasoning outputs against metadata contained in the usability profile, including cognitive load, sensory access, language access, interaction history, historical signals or usage patterns, or situational context, to confirm alignment with user needs and interaction constraints; and f) producing, via an output interface, a derived output tailored to the usability profile, the derived output comprising at least one of text simplification, language translation, alternative modalities including voice or haptic interfaces, modular content presentation, or markup customized according to the usability profile. This enables precise, user-centric adaptations that enhance accessibility, comprehension, and interaction efficiency across diverse contexts.

In yet another embodiment of the present invention, the prompt framework dynamically selects prompt engineering techniques, including chain-of-thought prompting, few-shot prompting, retrieval-augmented generation, or parameter-efficient adaptation, based on usability profile attributes such as reading speed, assistive technology usage, ambient noise, lighting conditions, device type, or historical interaction outcomes. This structured prompt framework enables user-aligned outputs, efficient model selection, and improved clarity, accessibility, and decision quality.

In yet another embodiment of the present invention, applying the prompt framework further comprises generating structured intermediate reasoning objects that record parsed entities, contextual cues, environmental indicators, usability-profile parameters, and preliminary transformation steps, which are stored for use in refining the usability profile and informing subsequent prompt-framework stages. This provides increased auditability and enables iterative refinement of personalization over time.

In still another embodiment of the present invention, the prompt framework includes a verification stage that incorporates responsive-loop signals derived from real-time behavioral feedback, sensor inputs, or environmental context to validate the suitability of selected models, prompt techniques, or modality decisions, and to adjust subsequent reasoning steps when observed interaction patterns indicate a need for modification. This reduces errors and adapts system behavior to changing user and environmental conditions.

In still another embodiment of the present invention, the prompt framework incorporates universal-design guidelines and domain-specific usability standards as constraints applied during model selection, prompt construction, and reasoning stages, thereby regulating simplification thresholds, modality selection, and content structuring to ensure consistency with the user's cognitive, sensory, motor, or language-access needs. This promotes inclusivity and consistency while mitigating compliance risk.

In still another embodiment of the present invention, the usability profile includes deriving one or more parameters from behavioral indicators, environmental context, declared preferences, sensor data, or historical usage patterns. This enables enhanced personalization, improved predictive accuracy, and optimized user experience.

Further objectives, features, and advantages of the present invention will become apparent upon review of the following detailed disclosure, the drawings, and the appended claims. Those skilled in the art will realize that different features of the present invention can be combined to create embodiments other than those described in the following.

### BRIEF DESCRIPTION OF DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention and should not be taken as limiting its scope. Various aspects, as well as embodiments of the present invention, are better understood by referring to the following detailed description. To better understand the invention, the detailed description should be read in conjunction with the drawings. With this caveat, embodiments of the invention will be described and explained with additional specificity and detail through the use of the accompanying drawings in which:

FIG. 1 illustrates a system for responsively optimizing usability for a user across a range of usability needs in accordance with an exemplary embodiment of the present invention;

FIG. 2 illustrates a usability profile in accordance with an exemplary embodiment of the present invention;

FIG. 3 illustrates a schema transformation engine (LLM/AI Agent) in accordance with an exemplary embodiment of the present invention;

FIG. 4 illustrates an artificial intelligence (AI) agent/large language module (LLM) controller in accordance with an exemplary embodiment of the present invention;

FIG. 5 illustrates a business usability analytics dashboard in accordance with an exemplary embodiment of the present invention;

FIG. 6 illustrates a domain-specific input in accordance with an exemplary embodiment of the present invention;

FIG. 7 illustrates a method for responsively optimizing usability for a user across a range of usability needs in accordance with an exemplary embodiment of the present invention;

FIG. 8 illustrates a method for generating a usability-adapted derived output using a structured prompt framework, in accordance with an exemplary embodiment of the present invention;

FIG. 9 illustrates an exemplary user interface displayed on a computing device for initiating an interaction and capturing multimodal user signals, contextual information, and service-provider data, in accordance with an embodiment of the present invention;

FIG. 10 illustrates an exemplary user interface showing a schema transformation engine and a model selection and decision pane applied to the user input, in accordance with an embodiment of the present invention;

FIG. 11 illustrates an exemplary user interface displaying intermediate reasoning outputs generated by the system or the computing device during adaptive transformation of the standardized input, in accordance with an embodiment of the present invention; and

FIG. 12 illustrates an exemplary user interface presenting a personalized, multimodal derived output generated according to the evolving usability profile, in accordance with an embodiment of the present invention.

The illustrated embodiments are merely examples and are not intended to limit the disclosure. The schematics are drawn to illustrate features and concepts and are not necessarily drawn to scale.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented and the requirements of a particular application may yield multiple alternatives and suitable approaches for implementing the functionality of any detail described herein. Therefore, any approach may extend beyond certain implementation choices in the following embodiments.

Methods of the present invention may be implemented by performing or completing, executing manually, automatically, or a combination thereof, selected steps or tasks. The term “method” refers to manners, means, techniques, and procedures for accomplishing a given task, including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

The present disclosure provides a responsive, AI-powered system for detecting and dynamically optimizing user experience for users with varied abilities and interaction contexts. The system is designed to support users across the full spectrum of abilities, including users with no impairments, low or temporary limitations, situational limitations, changing preferences, or significant accessibility requirements. As used throughout this disclosure, the terms “AI agents” and “LLMs” (Large Language Models) refer to autonomous or semi-autonomous systems designed to perceive input, interpret context, make decisions, and execute tasks to achieve specific objectives. The disclosed system may comprise one or more AI agents, one or more LLMs, or both, depending on the implementation. In many embodiments, LLMs serve as reasoning, language-understanding, or data-transformation components within broader AI agent frameworks.

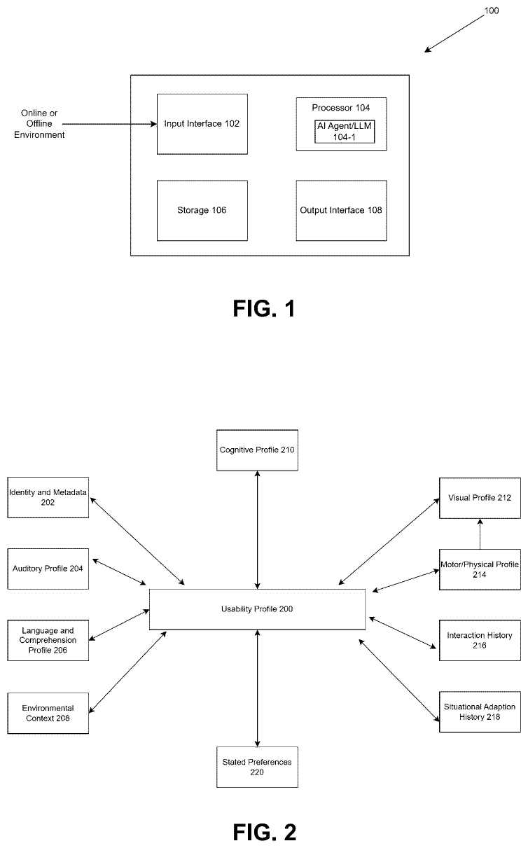

FIG. 1 illustrates a system 100 for responsively optimizing usability for a user across a range of usability needs in accordance with an exemplary embodiment of the present invention. The system 100 is designed as a modular framework composed of interoperable software components implemented using cloud platforms, on-device compute infrastructure, and API-accessible AI services. The system 100 comprises an input interface 102, a processor 104, a storage 106, and an output interface 108.

The input interface 102 captures user signals, behavioral indicators, sensor data, data originating from learning/education platforms, or service provider data from an online or offline environment. The online environment refers to data originating from internet-connected or digital networked systems, including but not limited to cloud-based applications, communication portals, learning/education platforms, or digital service platforms. The offline (onsite) environment refers to data captured from physical or localized systems in which users interact directly with embedded, printed, or point-of-interaction devices, such as point-of-sale terminals, government service kiosks, healthcare management systems, or other facility-based data sources. These sources include point-of-sale systems, payment processors, educational/learning content (including but not limited to learning plans, assessments, chat logs, and interactive voice response (IVR) systems), healthcare platforms, chat servers, and government portals. This integration allows seamless communication and automated data exchange across different environments, supporting diverse business and service operations. The input interface 102 collects, normalizes, and preprocesses structured, semi-structured, and unstructured data for subsequent transformation. Data is ingested into the input interface 102 via APIs, messages, queue subscribers (for example, Kafka consumers), or database connectors, thereby enabling interoperability with heterogeneous information systems. The input interface 102 supports structured, semi-structured, and unstructured data formats and performs normalization as a preprocessing step for downstream processing, thereby enabling interoperability with heterogeneous information systems. Data from the online or offline environment may be received via one or more computing devices. The responsiveness enables the platform to initiate preventive interventions that mitigate or prevent the development of adverse usability outcomes, thereby improving accessibility.

The input interface 102 captures behavioral and contextual data, including touch input latency, voice input usage, assistive technology toggles, accelerometer readings, ambient noise levels, geolocation, or user navigation flow. On-device sensors perform real-time monitoring, while event logs, telemetry data, and interaction signals may be streamed or periodically synced to cloud-based components for advanced analysis. These indicators are used to detect potential usability breakdowns across both physical and digital environments. The computing device serves as the primary interface for user interaction and data capture, including personal, shared, or embedded devices, enabling users to interact with content and services and/or to provide data input. The computing device includes, but is not limited to, a smartphone, an electronic device, a tablet, a kiosk, a laptop, a wearable device, a voice assistant, or an embedded system. In one example, the computing device may serve as both an input and output source. In one scenario, the computing device may present prompts, UI components, interactive flows, and accessibility-enhanced content to the user. In another scenario, the computing device may capture user signals (for example, speech, touch, gestures), sensor data (for example, location, ambient noise, network quality, or lighting), and usage behaviors. In yet another scenario, the computing device provides a range of adapted outputs, including audio cues, screen readers for visually impaired users, haptic feedback (such as vibrations or touch sensations), simplified visual layouts, and content translated into various languages. These features ensure that information is accessible to the users with different needs by presenting it in multiple formats and enhancing inclusivity.

The input interface 102 captures data from external information sources, including but not limited to digital systems (e.g., portals, POS) and physical systems (e.g., printed signage, menus, forms). The data is captured via camera, microphone, network interface, screen scraping, or API access. The computing device operates independently using on-device computing, connects to cloud-based components, or participates in a hybrid architecture, depending on the deployment context.

The input interface 102 is communicatively coupled with the processor 104 using a network. The network employs a wired or wireless communication network for communication. The network used for communication support any number of suitable wireless data communication protocols, techniques, or methodologies, including radio frequency (RF), infrared (IrDA), Bluetooth, ZigBee (and other variants of the IEEE 10 802.15 protocol), a wireless fidelity (Wi-Fi) or IEEE 802.11 (any variation), IEEE 802.16 (WiMAX or any other variation), global apparatus for mobile communication (GSM), general packet radio service (GPRS), enhanced data rates for GSM Evolution (EDGE), long term evolution (LTE), cellular protocols (2G, 2.5G, 2.75G, 3G, 4G or 5G), near field communication (NFC), satellite data communication protocols, or any other protocols for wireless communication.

The processor 104 deploys a schema transformation engine that uses one or more artificial intelligence (AI) agents or large language models (LLMs) 104-1 to transform captured unstructured or semi-structured data into structured data based on a schema. This provides a standardized format suitable for downstream processing and generating a usability profile. The schema transformation engine detects, parses, and transforms the captured unstructured or semi-structured data into standardized intermediate formats suitable for AI-powered processing and usability adaptation. The schema transformation engine includes pattern recognition, schema inference, format translation, or a prompt-based conversation using LLMs, enabling interoperability across data sources. The schema transformation engine detects and responds to the schema, structure, and format of input data pipes or intermediate representations such as Kafka event formats, SQL schemas, JSON documents, or XML files. The schema transformation engine performs responsive transformations into standardized formats, making the output suitable for downstream processing. Transformation logic may include pattern recognition, schema inference, format translation, or a prompt-based conversion using LLMs or AI agents, enabling robust interoperability across data sources. Alternatively, LLM(s), networked LLM(s), AI Agent(s), networked AI agent(s), AI Agent(s), and LLM(s) may also be used. Structured schema information refers to predefined data formats and structural definitions such as SQL schemas, JSON schemas, XML structures, or streaming formats like Kafka schemas that describe how data is organized, transmitted, and interpreted. This information enables the system 100 to detect, parse, and transform external data sources into standardized intermediate formats suitable for further AI-powered processing and usability adaptation. The one or more artificial intelligence (AI) agents or large language models (LLMs) 104-1 that apply techniques selected from prompt engineering, chain-of-thought prompting, few-shot learning, retrieval-augmented generation (RAG), parameter-efficient fine-tuning (PEFT), low-rank adaptation (LoRA), or reinforcement learning from human feedback (RLHF) to reason over the standardized format and generate transformations tailored to the usability profile and universal design guidelines. For example, the LLM may use a chain-of-thought prompting approach to analyze a user's low reading speed (as indicated in the usability profile) and a long, complex text input, and then generate a simplified text transformation. The AI agent and LLM controller 104-1 serve as the system's 100 orchestration hub and may manage one or more LLMs and/or AI agents, individually or in combination. The AI agent and LLM controller, or the AI agent and LLM, are used interchangeably throughout the description and convey the same meaning. It is responsible for selecting and configuring the appropriate models, routing prompts and structured data, executing adaptive transformations, monitoring real-time feedback, and responsively adjusting usability strategies. The processor 104 may invoke specialized AI techniques to ensure outputs are optimized for the user's current needs and environmental conditions. This component integrates with LLMs via APIs or local inference engines, operating in real time to drive personalized, responsive interactions. The processor 104 may be integrated within the input interface 102. Alternatively, the processor 104 may be located remotely from the input interface 102. The processor 104 may comprise a single or multi-core processor. The processor 104 executes software instructions or algorithms to implement functional aspects of the present invention. The processor 104 may be a cloud server. The processor 104 may also be implemented as a digital signal processor (DSP), a microcontroller, a system-on-chip (SoC), an integrated circuit implemented with a field-programmable gate array (FPGA), an application-specific integrated circuit (ASIC), or a combination thereof. The processor 104 may be implemented using a co-processor for complex computational tasks. The processor 104 uses stored logic to execute and control multiple operations simultaneously. The processor 104 may include one or more specialized hardware, software, and/or firmware modules (not shown) configured with particular circuitry, instructions, algorithms, or data to perform the functions of the disclosed methods. The processor 104 may be a general-purpose computer processor that executes commands or instructions but may utilize any of a wide variety of other technologies, including special-purpose hardware, a microcomputer, mini-computer, mainframe computer, programmed micro-processor, micro-controller, peripheral integrated circuit element, a customer-specific integrated circuit (CSIC), a logic circuit, a programmable logic device (PLD), a programmable logic array (PLA), RFID processor, smart chip, or any other device or arrangement of devices that are capable of implementing the operations of the processes of embodiments of the system 100.

The storage 106 is configured to maintain and update the usability profile and metadata. The profile is implemented as a structured data object (e.g., JSON or Protobuf) that stores scores and metadata across dimensions such as cognitive load, sensory access, language access, preferences, interaction history, real-time feedback, sensor inputs, historical usage patterns, environmental context, situational adaptation history, or other interaction parameters. The processor 104 tracks preferences, interaction history, device configuration, and cognitive, visual, auditory, physical, or language-based usability factors. Profiles may be updated using real-time feedback, one or more sensor inputs, and historical signals (stored and learned patterns). The usability profiles are continuously and responsively updated using a combination of component-level signals (for example, toggled screen readers, voice input failures), real-time feedback from the user's ongoing interaction, sensor inputs from on-device or cloud-based sources, and learned historical patterns from prior sessions. This dynamic, adaptive profiling capability enables the system 100 to detect emerging usability needs and automatically reconfigure its behavior and outputs to suit updated user contexts, behaviors, and interaction conditions. Critically, the usability profile also serves as an active feedback mechanism that can influence and update its component attributes. For example, sustained patterns in user interaction may cause the profile to refine its internal estimation of cognitive load, adjust simplification thresholds, or update stated preferences. In this bidirectional model, the usability profile not only aggregates component data but also drives refinements to those components over time, ensuring a continuously optimized, self-adjusting representation of user needs.

The usability profile is a structured, updated representation that captures a wide range of usability-relevant attributes and contextual information. The usability profile includes one or more parameters derived from behavioral indicators, environmental context, declared preferences, sensor data, or historical usage patterns. The metadata comprises cognitive load, sensory access, language access, preferences, interaction history, real-time feedback, sensor inputs, historical signals, environmental context, situational adaptation history, or other interaction parameters. The metadata may include the following components:

Identity & Metadata: User ID (anonymized or pseudonymized), session ID, region, locale, device type, or OS.

Cognitive Profile: Inferred reading speed, task completion time, cognitive load markers, or simplified content preference. For example, a high cognitive load marker may trigger the simplification of interface text.

Visual Profile: Screen reader use, font/contrast preferences, or zoom behavior.

Auditory Profile: Captions enabled, voice command success/failure, or preference for audio vs text.

Motor/Physical Profile: Input modality, gesture precision, or assistive tool usage.

Language & Comprehension: Detected or declared language, vocabulary range, language switching patterns, or translation history.

Interaction History: Prior services used, format preferences (text/audio/visual), or content types avoided or repeated.

Environmental Context: Ambient noise level, lighting, motion, network quality, or location.

Situational Adaptation History: Changes made during prior sessions (example, activated voice-only mode temporarily).

Stated Preferences: Explicit usability preferences (example, “Always show large text”, “Prefer audio prompts”, “Low complexity mode”) or declared impairment categories.

These attributes collectively inform how the system 100 transforms, routes, formats, and delivers content and interface logic in real time.

The processor 104 may be coupled to the storage 106. The storage 106 may include any of the volatile memory elements (for example, random access memory, such as DRAM, SRAM, or SDRAM), non-volatile memory elements (for example, ROM, or hard drive), magnetic, semiconductor, tape, optical, removable, non-removable, or other types of storage device or tangible and combinations thereof. Typical forms of non-transitory media include, for example, a flash drive, a flexible disk, a hard disk, a solid state drive, magnetic tape or other magnetic data storage medium, a CD-ROM or other optical data storage medium, any physical medium with patterns of holes, a non-transitory computer-readable medium, RAM, a PROM, and

EPROM, a FLASH-EPROM, other flash memory, NVRAM, a cache, a register, other memory chip or cartridge, or networked versions of the same. The storage 106 may have a distributed architecture, in which various components are located remotely from one another but can be accessed by the processor 104. Alternatively, the storage 106 may be local or remote, depending on the type of processor 104. The storage 106 may include one or more software programs or algorithms, each of which provides an ordered list of executable instructions for implementing logical functions.

The output interface 108 for presenting a derived output. The derived output is presented as a training dataset for one or more artificial intelligence (AI) systems. Alternatively, the output interface presents the derived output as an inference dataset to one or more artificial intelligence (AI) systems. The output interface 108 employs an output personalization engine to generate the derived output. The derived output includes at least one of the following: text simplification, language translation, alternative modalities (including voice or haptic interfaces), modular content presentation, markup customized according to the usability profile, or any other service tailored to the usability profile. For example, if the usability profile indicates a severe vision impairment, the derived output may be presented as a stream of structured haptic feedback and simplified, high-contrast text. The output interface 108 presents the derived output as a training dataset for one or more artificial intelligence (AI) systems. The output personalization engine applies transformations using rule-based templates, LLM-generated markup, or UI rendering components customized per profile. The output interface 108 sends transformed outputs to the user's device or a designated system (e.g., an AI agent, an LLM, a database, or a UI rendering service). Formats are determined based on the usability profile, environmental context, and platform compatibility. The system 100 may use HTTP, MQTT, WebSocket, or mobile push notification protocols to deliver responses in real time or in a deferred manner.

FIG. 2 illustrates a usability profile 200 in accordance with an exemplary embodiment of the present invention. The storage (as discussed in FIG. 1) maintains and updates the usability profile 200 for each user. The usability profile 200 is implemented as a structured data object, such as a JavaScript Object Notation (JSON) structure or a Protocol Buffer (Protobuf) schema. The usability profile 200 is designed to store scores, metrics, and metadata across a plurality of usability dimensions, including, but not limited to, cognitive load, sensory accessibility, language access, preference, interaction history, real-time feedback, sensor input, historical signals, environment context, situational adaptation history, and motor interaction.

The usability profile 200 continuously monitors and records user-specific parameters, including preferences, interaction history, device configuration, and usability factors associated with cognitive, visual, auditory, physical, or linguistic behaviors. The usability profile 200 is dynamically updated based on a combination of component-level signals (e.g., toggled screen readers, voice input failures, or gesture errors), real-time user feedback, multimodal sensor inputs from on-device or cloud-based sources, and historical interaction signals that represent learned behavioral patterns from prior user sessions. By integrating these signals, the usability profile 200 is continuously and adaptively refined, enabling the detection of emerging usability needs and the autonomous reconfiguration of system behavior, content delivery, and interface logic in accordance with the user's evolving context and interaction conditions.

In one scenario, the usability profile 200 functions as an active feedback entity that can influence and update its constituent attributes. Sustained trends or repetitive interaction patterns cause the profile to automatically refine its internal estimates of cognitive load, adjust content-simplification thresholds, or revise inferred language preferences. This establishes a bidirectional feedback mechanism in which the usability profile 200 not only aggregates usability data but also initiates modifications to the underlying adaptive components, thereby ensuring a continuously optimized, self-adjusting representation of user needs.

The usability profile 200 comprises multiple structured components, including, but not limited to, the following:

Identity and Metadata 202: Includes anonymized or pseudonymized user identifiers, session identifiers, locale, region, device type, and operating system information.

Auditory Profile 204: Records auditory accessibility indicators, including caption usage, voice command success and failure rates, and audio versus text preference.

Language and Comprehension Profile 206: Defines declared or inferred language preferences, vocabulary range, translation behavior, and language-switching patterns.

Environmental Context 208: Captures ambient environmental conditions, including noise levels, lighting conditions, network performance, motion state, and location context.

Cognitive Profile 210: Represents parameters such as inferred reading speed, task completion duration, cognitive load indicators, and content simplification preferences.

Visual Profile 212: Captures visual interaction preferences, including font size, contrast levels, zoom behavior, and screen reader activation.

Motor and Physical Profile 214: Reflects input modalities, gesture precision, and dependency on assistive tools or devices.

Interaction History 216: Includes prior content or service usage, preferred interaction formats (text, audio, or visual), and recurring or avoided content patterns.

Situational Adaptation History 218: Records temporary or session-based usability modifications such as activation of voice-only modes or simplified interface configurations.

Stated Preferences 220: Stores explicitly declared usability or accessibility preferences, including but not limited to “always show large text,” “prefer audio prompts,” or “low complexity mode.”

Collectively, these components form an evolving, context-aware representation that enables the system to transform, route, format, and deliver content or interface elements in a way that continuously aligns with the user's individualized, dynamically changing usability requirements. The usability profile 200 thus establishes a feedback-driven, adaptive framework for optimizing user experience across varying devices, environments, and cognitive conditions.

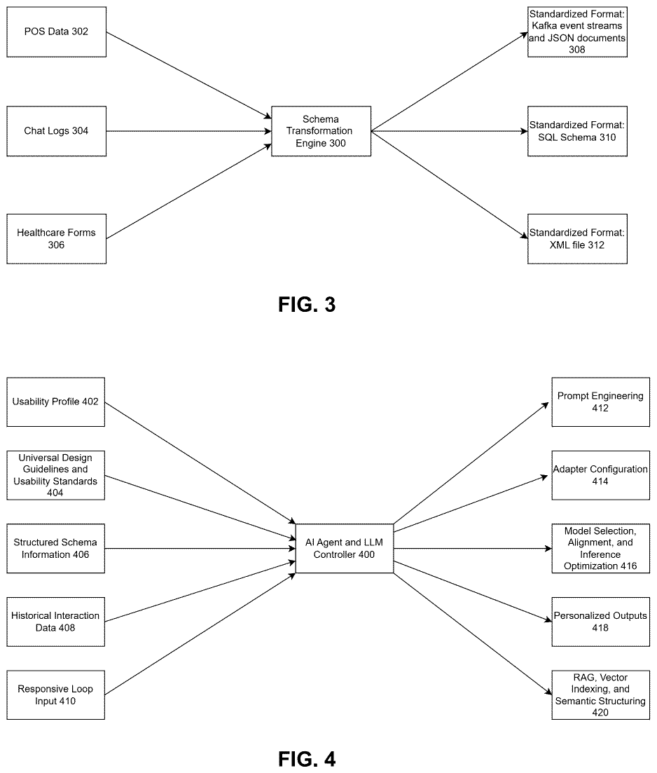

FIG. 3 illustrates a schema transformation engine 300 (LLM/AI Agent) in accordance with an exemplary embodiment of the present invention. The schema transformation engine 300 is positioned as the intelligent intermediary that converts raw, heterogeneous data streams captured through the input interface into standardized, semantically enriched, and usability-annotated structures ready for downstream AI reasoning and personalization. Powered by a coordinated ensemble of artificial intelligence agents and large language models, the schema transformation engine 300 executes real-time pattern detection, schema inference, format translation, and context-aware prompt-driven refinement, ensuring seamless interoperability across online and offline environments while embedding critical usability metadata directly into the transformed output. This enables the system to adapt content delivery not only for technical compatibility but also for perceptual and cognitive accessibility across diverse user profiles and deployment contexts, ranging from smartphones to public kiosks.

The schema transformation engine 300 receives point-of-sale (POS) data 302 as a continuous stream of transactional events, often semi-structured and cluttered with vendor-specific codes, promotional footnotes, and timestamp variations. For example, a fuel station pump generates a record containing “Fuel: Diesel|Qty: 45.2 L|Amt: 4,562|Card: XXXX-7890|Time: 17:32”. The schema transformation engine 300 applies pattern recognition to isolate transactional entities, infers hierarchical relationships such as line items within a receipt, and outputs a normalized JSON structure: a compact voice summary in English for a truck driver (“Forty-five liters of diesel, fifty-four dollars, paid by card, paid by card”) accompanied by a large-font digital receipt with high-contrast colors, automatically triggered based on detected ambient light and language preference.

Furthermore, chat logs 304 arrive as unstructured, multilingual, and emotionally charged conversational threads from customer service platforms or in-app messaging systems. A typical input might read: “Why is my refund still pending? 3 weeks already!! Order #ORD98765”. Using prompt-based LLM reasoning, the schema transformation 300 engine parses intent, extracts structured entities, assesses urgency through sentiment and punctuation density, and generates a standardized support incident schema:
“Incident_id”: “INC20251106-001”,
“Order_ref”: “ORD98765”,
“Issue_type”: “Refund_delay”,
Urgency_score”: 0.92,
“User_state”: {“cognitive_load”: “high”, “preferred_modality”: “voice”},
“Action_summary”: “Escalate to the finance team, send an apology in Spanish via voice call”.

This structured output triggers an automated voice apology with simplified status updates, reducing user frustration and agent workload.

Healthcare forms 306 are entered as scanned paper documents, PDFs, or HL7 messages, with mixed typed and handwritten content. A patient discharge summary, for instance, contains handwritten notes: “Continue Tab. Metformin 500 mg BD, diet control, follow-up 1 month”. The schema transformation engine 300 performs optical character recognition, clinical entity extraction, and schema mapping to produce a FHIR-aligned observation bundle. The output includes plain-language voice narration in English (“Take one tablet after breakfast and dinner. Eat less sugar. Return after thirty days”) synchronized with a large-print summary card and optional haptic reminders on a connected smartwatch, ensuring adherence among elderly patients with low literacy or visual impairments.

The schema transformation engine 300 also processes Kafka event streams and JSON documents 308 from high-throughput microservices or IoT networks. A smart parking system emits real-time events: {“bay”: “B12”, “status”: “occupied”, “entry”: “2025-11-06T17: 15:00”, “vehicle”: “KA-01-MH-4567”}. The schema transformation engine 300 validates against a dynamic schema registry, enriches the data with contextual metadata (for example, proximity to accessible ramps), and outputs a structured availability feed. For a wheelchair user, this triggers a voice-guided navigation prompt: “Accessible spot B12 now free, two hundred meters ahead, turn left” with continuous haptic pulses aligned to walking pace.

SQL schemas 310 are ingested as relational metadata from legacy enterprise systems. A hospital patient table, defined as CREATE TABLE admissions (pid INT, name VARCHAR (100), ward ENUM (‘ICU’, ‘GEN’), admit_date DATE), is mapped into a flexible knowledge graph. When queried by a visually impaired nurse via voice command (“Who is in the general ward?”), the schema transformation engine 300 generates a spoken roll call with pause-on-name functionality and optional Braille display output, transforming rigid tabular data into an accessible, interactive audio interface.

XML files 312, prevalent in government and financial integrations, arrive with deeply nested structures and domain-specific vocabularies. A tax filing extract might include:
“<Return> <Form16> <TDS> <Entry> <Amount>85,000</Amount> </Entry> </TDS> </Form16> </Return>”

The engine applies XSD inference and flattens hierarchies. The output is a modular, voice-navigable summary: “Total tax deducted: one thousand twenty dollars” delivered in English, with tappable audio segments and a simplified visual timeline for deaf users, ensuring equitable access to complex fiscal information.

The transformation logic operates through a layered, adaptive pipeline. Pattern recognition identifies recurring motifs across input examples, detecting invoice totals via currency symbols and numeric clustering. Schema inference hypothesizes missing attributes. When a chat log mentions “flight delayed” without a number, the engine cross-references prior interactions to infer “FLIGHT-IND456”. Format translation converts between serialization paradigms, such as CSV to Avro and JSON to Protobuf. Prompt-based LLM conversions handle narrative or ambiguous content via structured dialogue:

{System: Extract medication, dosage, and delivery preference from note.
Input: “Give insulin before meals, avoid if shaking”.
Output:
   “Drug”: “Insulin”,
   “Timing”: “Pre-meal”,
   “Condition”: “Avoid_if_hypoglycemic_shaking”,
   “Delivery: “Voice_reminder+vibration_alert”,
   “Language”: “simplified_English”}

This ensures clinical accuracy and patient safety through accessible reminders.

The resulting structured schema information forms a living, versioned repository of data contracts, encompassing SQL DDL, JSON Schema, XML namespaces, and streaming schemas, which evolve over time and are stored in the storage. It serves as the canonical reference for validation, transformation, and enrichment. In a smart retail kiosk, this enables the fusion of POS transactions, loyalty JSON, and inventory XML into a unified customer profile, in which each data point includes interaction history, environmental context, and adaptation metadata. The schema transformation engine 300 thus automates schema evolution, reduces integration friction, and embeds universal design principles at the data layer, ensuring that every derived output, whether a voice summary, haptic alert, or simplified form, is not only interoperable but perceptually optimized, contextually relevant, and inclusively delivered across the full spectrum of human ability and preference.

FIG. 4 illustrates an artificial intelligence (AI) agent/large language module (LLM) controller 400 in accordance with an exemplary embodiment of the present invention. The AI agent/LLM controller 400 functions as the central cognitive orchestration engine within the system architecture. This controller 400 dynamically instantiates, coordinates, and adapts one or more AI agents and LLMs either independently or in hybrid ensembles to execute responsive reasoning, schema-aware transformation, and personalized content generation. Operating in real-time across diverse deployment environments such as smartphones, wearables, kiosks, or embedded systems, the AI agent/LLM controller 400 integrates inputs from the input interface, processes them through the schema transformation engine, and routes structured outputs to the output personalization engine, ensuring end-to-end alignment with evolving usability profiles and universal design principles.

The AI agent/LLM controller 400 ingests the usability profile 402 as its foundational input, representing a multidimensional, continuously updated user model stored in system storage. This profile aggregates metadata dimensions, such as cognitive load (example, inferred from typing speed variance>30% indicating stress), sensory access (example, screen reader usage detected via OS accessibility APIs), language access (example, primary Spanish with secondary English fallback), and interaction history (example, 87% preference for voice confirmation over text in noisy environments). For instance, in a public transportation kiosk, a visually impaired commuter's profile triggers high-contrast, large-font outputs with synchronized haptic wayfinding pulses. At the same time, a non-native speaker receives real-time Spanish transliteration with phonetic pronunciation guides.

The AI agent/LLM controller 400 applies techniques selected from prompt engineering, chain-of-thought prompting, few-shot learning, retrieval-augmented generation (RAG), parameter-efficient fine-tuning (PEFT), low-rank adaptation (LoRA), or reinforcement learning from human feedback (RLHF) to reason over the standardized format and generate transformations tailored to the usability profile and universal design guidelines.

Complementing this are universal design guidelines and usability standards 404, injected as structured constraint layers to enforce inclusivity and compliance. These include WCAG 2.2 success criteria (e.g., a minimum contrast ratio of 4.5:1 and operability via keyboard or voice), domain-specific regulations (e.g., HIPAA-compliant simplification of medical jargon), and organizational style guides (e.g., plain-language mandates for government forms). In practice, when processing a dense insurance policy PDF, the AI/LLM controller 400 applies these standards to cap sentence length at 20 words, replace passive voice with active voice, and generate alt-text for all embedded charts, ensuring that outputs meet both legal and perceptual accessibility thresholds.

Structured schema information 406 serves as the normalized backbone for all downstream reasoning, derived from the schema transformation engine's parsing of unstructured or semi-structured inputs. This input includes inferred ontologies (e.g., <appointment> {date, time, provider, purpose} </appointment>) and standardized intermediate representations (e.g., JSON-LD with usability annotations). For instance, a raw SMS from a clinic, “Dr. Rao appt 10 am tomorrow,” is transformed into a structured event node with fields for urgency, location, and modality preferences, enabling precise prompt construction and RAG retrieval.

Historical interaction data 408 provides longitudinal context, replayed from storage to inform few-shot learning and pattern detection. This includes session transcripts, adaptation outcomes (e.g., 94% task completion when haptic cues were added post-failure), and environmental logs (e.g., ambient light <50 lux correlating with 3× zoom usage). In a retail voice assistant, this data enables the controller 400 to anticipate user intent. Upon hearing “find shoes”, it recalls prior purchases of size nine and proactively offers audio descriptions with tactile swatch feedback for color-blind users.

The responsive loop input 410 closes the adaptation cycle by streaming real-time behavioral signals and explicit feedback into the controller 400. Examples include mid-session gaze divergence (indicating confusion), voice stress markers (elevated pitch followed by simplification), or post-interaction ratings (for example, “Was this clear?”). In a telemedicine app, a patient's repeated “huh?” triggers immediate rephrasing from “administer 5 ml BID” to “take one teaspoon twice daily with food”, with the loop signal updating the profile to favor analog over clinical dosing language.

These inputs converge to drive a suite of advanced techniques, beginning with “prompt engineering 412”, which dynamically crafts context-rich, chain-of-thought (CoT) prompts tailored to user state and task. For example, instead of a generic query, the system generates:
[PROFILE: cognitive_load=high, modality=voice+haptic]
[GUIDELINES: WCAG 2.2, plain_language]
[INPUT: “Your blood pressure is 140/90”]
Step 1: Assess risk: elevated
Step 2: Simplify: “Your BP is a bit high”
Step 3: Add action: “Take your pill now”
Step 4: Deliver: “TTS+single vibration”

This structured reasoning ensures transparent, auditable transformations.

Adapter configuration 414 enables lightweight, parameter-efficient customization (example, via LoRA or PEFT) without retraining base models. For a financial app serving rural users, the controller 400 loads a dialect-tuned adapter that converts formal banking terms (“overdraft facility”) into local idioms (“extra borrowing bucket”), reducing comprehension time by 62% while preserving semantic fidelity.

Model selection, alignment, and inference optimization 416 dynamically orchestrates model routing and runtime efficiency. The controller 400 evaluates latency, accuracy, and energy constraints, selecting a 1.3 B-parameter on-device LLM for a smartwatch (with a sub-100 ms response) versus a 13 B cloud model for complex legal summarization. Alignment via RLHF weights rewards toward clarity and empathy, and inference is optimized with quantization, speculative sampling, and kernel fusion. Output example: a wearable generates a 3-word alert, “Pill. Now. Beep.” with perfect timing synced to medication reminders.

Personalized outputs 418 represent the final user-facing layer, encompassing text simplification, translation, and multimodal rendering. In an educational tablet app, a 300-word biology passage is reduced to:
Text: “Plants make food using sunlight” (Flesch-Kincaid grade 3).
Voice: “Slow, clear narration in English”.
Visual: “Animated diagram with tap-to-explore labels”.
Haptic: “Pulse on sunlight to reinforce the concept”.

This output is generated via a coordinated ensemble, with each modality verified against the usability profile.

Finally, retrieval-augmented generation (RAG), vector indexing, and semantic structuring 420 enrich generation with precise, profile-filtered knowledge retrieval. The system queries a vector store of prior user-approved content, for example, retrieving a simplified diabetes management guide rated 4.8/5 by similar cognitive profiles, and semantically structures it into modular chunks. Output: a medication schedule presented as voice-narrated steps with haptic ticks, auto-translated into English, and annotated with ARIA landmarks for screen readers.

The AI agent/LLM controller 400 integrates these components into a unified generation pipeline that supports iterative refinement via the responsive loop. For instance, if a user skips a voice prompt, the system logs disengagement, adjusts future outputs to shorter segments, and updates RAG indexes to prioritize concise analogs. This human-centric, domain-aware framework, leveraging APIs, local inference, and feedback-driven optimization, ensures that every reasoning step and generated artifact remains accessible, relevant, and adaptive across diverse users, contexts, and devices.

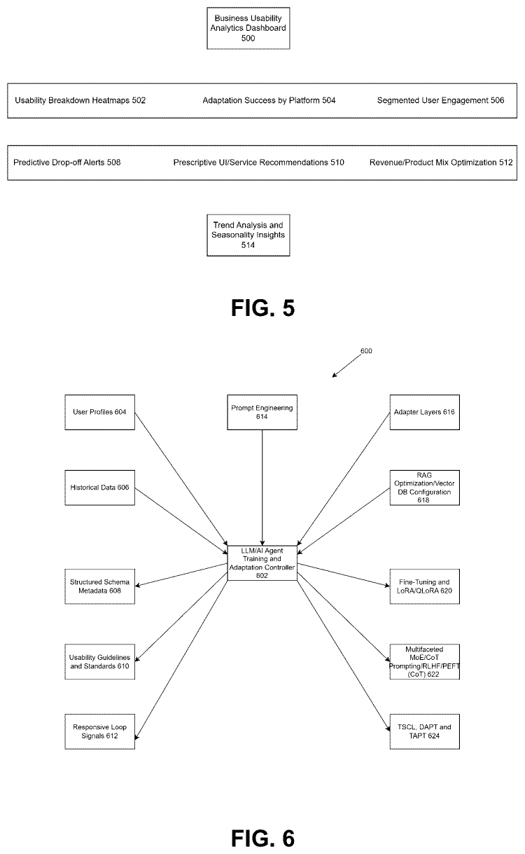

FIG. 5 illustrates a business usability analytics dashboard 500 in accordance with an exemplary embodiment of the present invention. The business usability analytics dashboard 500, with functions, serves as a centralized, AI-augmented intelligence layer that transforms aggregated usability metadata captured via the input interface and updated through storage mechanisms into actionable, predictive, and prescriptive business insights. This business usability analytics dashboard 500 ingests structured data outputs from the schema transformation engine, enriched with real-time usability profiles and longitudinal interaction metadata, to empower organizations with granular visibility into user experience friction, adaptation efficacy, and strategic optimization opportunities across digital and physical service touchpoints. Deployed on enterprise-grade platforms, such as cloud-based BI tools or embedded kiosks in retail environments, the business usability analytics dashboard 500 supports multi-stakeholder access from UX designers to C-suite executives, ensuring alignment between user-centric adaptations and business outcomes.

The business usability analytics dashboard 500 presents usability breakdown heatmaps 502 as interactive, color-gradient visualizations that pinpoint high-friction zones within user journeys, segmented by usability profile dimensions. For example, in a banking mobile app, the heatmap might highlight a 68% abandonment rate on the “ID verification” screen among users with high cognitive load (defined as session duration>3 minutes and repeated form resets), compared with 12% among low-load users. Color intensity (red to yellow to green) corresponds to error frequency, overlaid with tooltips revealing root causes, such as small font sizes triggering zoom gestures in elderly users or complex legal disclaimers overwhelming non-native speakers, enabling rapid user interface (UI) remediation.

Complementing this, platform 504's adaptation success quantifies the impact of system-generated transformations on task completion rates across device types. In a healthcare portal, the metric may show that voice-guided form-filling on wearables increases submission success from 54% to 91% for patients with motor impairments. In comparison, text simplification on tablets increases completion rates by 47% among users with reading difficulties. Bar charts compare pre- and post-adaptation performance, with statistical significance markers (e.g., p<0.01) and platform icons (smartphone, kiosk, laptop), guiding resource allocation toward high-ROI personalization strategies.

Segmented user engagement 506 dissect behavioral patterns across accessibility cohorts, rendered as stacked area charts or Sankey diagrams. For instance, on an e-learning platform, the visualization shows that visually impaired users spend 3.2 times longer on video content when haptic-synced captions are enabled, multilingual users exhibit 40% higher retention with auto-translated subtitles, and learners with high cognitive loads prefer modular, bite-sized lessons to dense paragraphs. These insights, filtered by demographic characteristics or session context (e.g., late-night usage), inform the design of inclusive content and personalized learning pathways.

The business usability analytics dashboard 500 incorporates predictive drop-off alerts 508, powered by real-time inference on usability profile indicators and session metadata. Using lightweight onboard ML models, the system forecasts the abandonment probability, for example, an 87% likelihood within 15 seconds, if a user with language access=“Spanish” encounters an English-only error message. Alerts appear as pulsing banners with intervention triggers, such as auto-switching to voice navigation, injecting a simplified Spanish prompt, or routing to a human agent. In a retail kiosk scenario, this prevents cart abandonment by pre-emptively enlarging “Proceed to Payment” buttons when eye-tracking detects prolonged hesitation.

Prescriptive UI/service recommendations 510 deliver AI-generated, ranked suggestions via natural language cards and mockup previews, derived from trend analysis across user segments. For a government service portal, the system might recommend: (1) Replace 400-word eligibility criteria with a 3-step voice quiz (projected+29% completion), (2) Implement haptic progress indicators for blind applicants (+18% satisfaction, (3) Auto-populate forms using sensor-detected context (example, location-based residency proof). Each recommendation includes A/B test simulations, cost estimates, and integration code snippets (example, ARIA-enhanced HTML), streamlining deployment.

Revenue and product mix optimization 512 correlates usability adaptations with commercial KPIs, presented in funnel visualizations. In a telecom app, the business usability analytics dashboard 500 might show that offering simplified, icon-driven plan comparisons in regional languages increases upselling conversion by 34% in rural areas. At the same time, voice-activated bundle selection boosts ARPU by $180/month among senior citizens. Heatmap overlays on product grids highlight high-engagement configurations (example, visual vs. auditory menus), enabling dynamic catalog curation and personalized nudges at the point of decision.

Trend analysis and seasonality insights 514 track temporal shifts in usability needs through line graphs and anomaly detection. For example, during rainy seasons in Spain, the system detects a 52% spike in voice interface usage because wet screens impair touch accuracy, prompting preemptive modality shifts. Demographic overlays reveal evolving preferences, such as Gen Z favoring haptic feedback over sound in public transit. At the same time, regional filters expose infrastructure gaps (e.g., higher drop-off rates in low-bandwidth zones). These longitudinal insights feed back into the schema transformation engine via the output interface, refining future training datasets for AI agents.

Beyond these core visualizations, the business usability analytics dashboard 500 surfaces operational efficiency metrics that quantify burden reduction and automation success attributable to usability enhancements. In a call center integration, metrics might show a 41% decrease in average handle time after implementing LLM-generated summary scripts tailored to agent cognitive load, or a 63% increase in first-contact resolution when customers receive preemptive, simplified FAQs in their preferred modality. These gains are plotted against cost savings and employee satisfaction scores, reinforcing the business case for inclusive design.

The predictive and prescriptive business analytics are rendered through the interactive business usability analytics dashboards 500 with drill-down capabilities, exported to data lakes in structured formats (example, Parquet with schema metadata) for integration with enterprise BI tools like Tableau or Power BI, or fed directly into the system's “machine learning and LLM pipelines” as high-value training signals. This closed-loop architecture enables continuous organizational learning and improvement. For instance, a retail chain utilizes the business usability analytics dashboard 500 to derive insights and refine its RAG system, thereby enhancing the relevance of product recommendations for multilingual shoppers. Across industries, retail (personalized checkout flows), healthcare (accessible teleconsultations), education (adaptive curricula), finance (inclusive onboarding), government (equitable service access), and nonprofits (donor journey optimization). The incorporation of analytics into LLM pipelines refines adaptive interaction models, enhances output personalization, and drives measurable improvements in engagement, equity, and efficacy.

FIG. 6 illustrates a domain-specific input 600 in accordance with an exemplary embodiment of the present invention. The domain-specific input 600 serves as a comprehensive orchestration hub that aggregates multifaceted data streams to drive the LLM/AI agent training and adaptation controller 602 toward highly personalized, context-aware model behaviors. The controller receives user profiles 604 as its primary input, which encapsulate a rich, evolving repository of individual user characteristics, preferences, and interaction patterns. For instance, a user profile for an elderly individual with visual impairments might include metadata on preferred font sizes (example, 18 pt minimum), high-contrast color schemes (example, black text on white background), simplified vocabulary levels (example, Flesch-Kincaid grade 5), and historical preferences for voice-assisted navigation over text-heavy interfaces. This input is captured in real time via the system's input interface from behavioral signals, such as dwell time on UI elements or explicit feedback (thumbs-up/down ratings), ensuring the profile dynamically adapts to reflect changing needs, including temporary situational impairments, such as operating a device in bright sunlight.

Complementing the user profiles are historical data 606 and structured schema metadata 608 (treated as interconnected inputs for schema normalization), which provide longitudinal context and standardized data frameworks. The historical data 604 encompasses past interaction logs, such as a sequence of user queries in a banking app (example, “check balance” followed by “transfer $50 to savings” with noted frustration via repeated back-button presses), sensor-derived environmental cues (example, GPS data indicating urban noise levels prompting louder audio outputs), and outcome metrics (example, task completion rates of 85% in low-light conditions). The structured schema metadata 608, inferred and transformed by the schema transformation engine, converts unstructured inputs like raw voice transcripts or semi-structured JSON from service providers into standardized formats, such as a unified XML schema with tags for <cognitive_load> (example, measured via pupil dilation from wearable sensors) and <language_access> (example, detecting multilingual code-switching in chat logs). An example involves parsing a messy email thread from a healthcare provider that contains mixed text, attachments, and emojis into a structured schema with fields such as patient ID, symptom description, and urgency score, enabling seamless downstream AI processing.

Additional inputs include usability guidelines and standards 610, which incorporate universal design principles and regulatory benchmarks to promote accessibility and inclusivity. These might draw on WCAG 2.2 standards (e.g., ensuring a 4.5:1 contrast ratio) or domain-specific norms (e.g., HIPAA for medical data privacy), applied as weighted constraints during the transformation process. For example, in an educational kiosk system, guidelines could mandate the presentation of modular content with alternative text for images, automatically generating captions such as “Bar chart showing population growth: Spain, from 39M in 2000 to 47M in 2023, for visually impaired users.

The final key input comprises responsive loop signals 612, forming a closed-feedback mechanism that captures continuous preference feedback, real-time interactions, and contextual updates to refine the system iteratively. Examples include in-session haptic feedback (example, vibration intensity adjusted based on user grip strength detected via smartphone sensors), post-interaction surveys (example, “Was this summary helpful? Yes/No” with follow-up voice notes), or environmental adaptations (example, switching to haptic alerts during a detected phone call). These signals are schema-normalized, transforming raw sensor streams like accelerometer data indicating hand tremors into structured <situational_adaptation_history> entries indexed into replay buffers for RLHF and RAG vector stores for rapid retrieval, then mapped to prompt templates (example, “Simplify this medical report for a user with cognitive load threshold 3”), adapter configurations (example, LoRA weights tuned for dyslexia-friendly phrasing), and mixture of experts (MoE) routing policies (example, routing text simplification queries to a specialized ‘accessibility expert’ module).

Once aggregated, the domain-specific input 600 guides the training and application of a wide range of advanced machine learning techniques, producing tailored outputs that improve model alignment with usability profiles. Prompt engineering 614 outputs dynamically crafted prompts, such as a chain-of-thought sequence:
Step 1: Identify key entities in the user query.
Step 2: Apply the usability profile (e.g., translate into English).
Step 3: Simplify to a grade 5 reading level, “resulting in an output like a voice-synthesized response: “Your balance is six dollars. Do you want to transfer money?” for a non-native English speaker.

Adapter layers 616 yield lightweight, parameter-efficient modifications, outputting specialized model behaviors without full retraining. For example, adding a PEFT adapter that transforms complex legal jargon in a contract app into bullet-point summaries with haptic emphasis on critical clauses.

RAG optimization/vector DB configuration 618 produces retrieved and fused content, such as pulling from a vector store of past user-approved translations to generate a contextually accurate output: a sign-language video avatar explaining weather alerts in modular segments.

Fine-tuning/low-rank adaptation (LoRA)/QLoRA 620 outputs compressed, domain-adapted models. For example, a QLoRA-tuned LLM that generates markup tailored to a usability profile, such as HTML with ARIA labels for screen readers in a wearable fitness tracker.

The multifaceted MoE/CoT prompting/RLHF/PEFT (CoT) 622 cluster generates reasoned, expert-routed responses, such as a CoT-guided output for a kiosk: “Reasoning: User has low vision: “Enlarge text and add voice”. Output: [Enlarged button: ‘Confirm Purchase]+TTS: “Press to buy for 100 dollars”.

Additional techniques, such as prefix/task-specific context layering (TSCL), domain-adaptive pre-training (DAPT), and task-adaptive pre-training (TAPT) 624, output layered contexts. For example, prefixing all responses with user-specific haptic patterns for a blind user. This integration ensures outputs are verified iteratively via the responsive loop, updating elements for subsequent cycles.

Furthermore, domain-specific usability information drives fine-tuning strategies: instruction fine-tuning outputs task demonstrations (example, “Input: Dense report, Output: Simplified version with icons”), PEFT/feature extraction yields fixed extractors for quick modality shifts (example, text-to-haptic), full fine-tuning produces wholly retrained models for high-stakes domains like voice assistants, supervised fine-tuning uses labeled datasets (example, 10,000 accessibility-rated responses), hyperparameter tuning optimizes rates for latency-sensitive wearables, and transfer learning adapts e-commerce models to healthcare.

For RAG systems, outputs include selectively retrieved content (example, pulling only high-usability snippets from a medical database) incorporated via fusion prompts, yielding highly relevant responses like a translated, simplified drug interaction warning with voice and visual alternatives, ensuring accuracy, relevance, and contextual fit per the output personalization engine and derived output modalities.

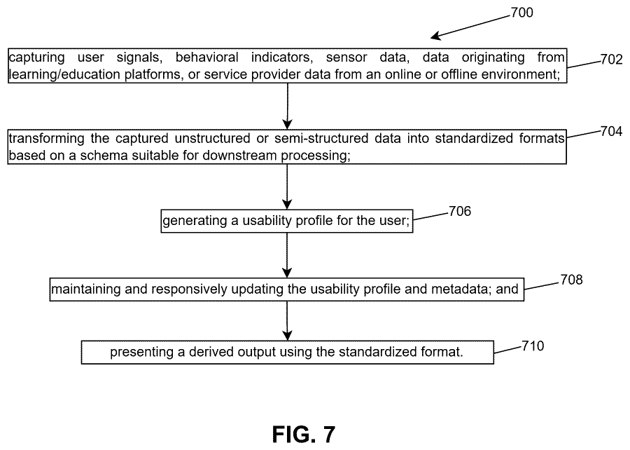

FIG. 7 illustrates a method 700 for responsively optimizing usability for a user across a range of usability needs in accordance with an exemplary embodiment of the present invention. The method 700 comprises the steps of:

Capturing Data: a) capturing 702, user signals, behavioral indicators, sensor data, data originating from learning/education platforms, or service provider data from an online or offline environment. This includes collecting behavioral and contextual data such as user interaction data (example, selections, input, navigation), sensor inputs (example, audio cues, screen reader toggling), data originating from learning or education platforms (such as quiz responses, lesson progress metrics, or adaptive learning module interactions and relevant service data (example, digital menus, forms, transaction summaries). The method 700 operates concurrently to gather a comprehensive set of inputs for real-time usability assessment.

Transforming Data: b) transforming 704, the captured unstructured or semi-structured data into standardized formats based on a schema suitable for downstream processing. A processor processes the captured unstructured or semi-structured data by deploying a schema transformation engine. This engine, using one or more artificial intelligence (AI) agents or large language models (LLMs), identifies the data format (e.g., Kafka topics, SQL tables, or raw text) and converts the data into standardized intermediate formats, based on a schema, suitable for downstream processing. The transformation includes pattern recognition, schema inference, format translation, and prompt-based conversation, enabling seamless interoperability across diverse data sources while generating a usability profile relevant to the user's context.

Generating Usability Profile (Step 706): The method generates 706 a dynamic usability profile for the user. The usability profile comprises one or more parameters derived from interaction behavior, environmental context, declared preferences, sensor inputs, and/or historical usage patterns. This step assembles profile attributes, including cognitive load indicators, sensory access needs (e.g., visual impairments or haptic preferences), language proficiency levels, reading speed metrics, assistive technology use, ambient conditions (e.g., noise or lighting), device interaction history, and situational adaptation records. The process operates continuously to refine the profile in real time, enabling proactive usability optimization and preventive interventions to address diverse user needs.

Maintaining and Updating Profile (Step 708): d) maintaining and responsively updating 708, the usability profile, and metadata. A dynamic usability profiler maintains and updates the usability profile and associated metadata within storage. Metadata includes cognitive load, sensory access, language access, preferences, interaction history, real-time feedback, sensor inputs, historical signals, environmental context, and situational adaptation history. The usability profile includes deriving one or more parameters from behavioral indicators, environmental context, declared preferences, sensor data, or historical usage patterns. The responsive loop continuously captures interaction signals (e.g., user adjustments, delays, navigation patterns) to update and refine the usability profile and metadata in real time or for future adaptability.

Presenting Output (Step 710): e) presenting 710, a derived output using the standardized format. An output personalization engine, operating within an output interface, generates a derived, customized output based on standardized data and the current usability profile. The output may include text simplification, transformation into different languages, alternative modalities such as voice-guided navigation or haptic feedback, modular content presentation, or markup customization tailored to the user's needs. The final output is delivered via a delivery interface back to the originating device or forwarded to other AI systems, service backends, or user agents. In some cases, this output also serves as a training dataset for additional AI-based systems.

The method 700 is implemented on various devices, including smartphones, electronic devices, tablets, kiosks, laptops, wearables, voice assistants, or embedded systems, enabling broad applicability across computing environments.

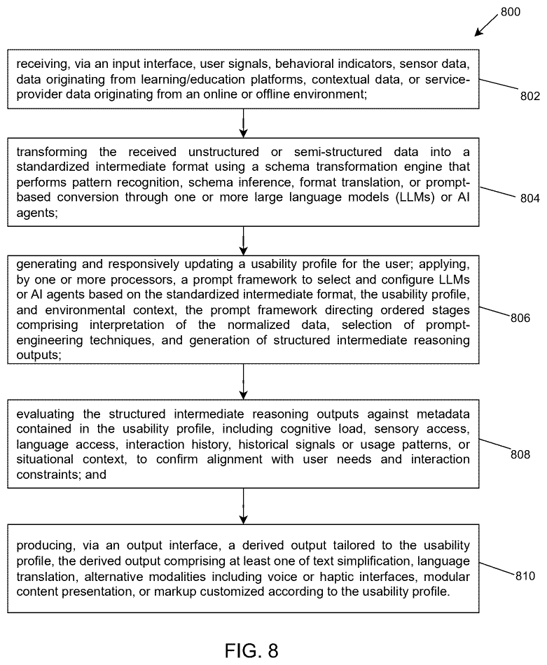

FIG. 8 illustrates a method 800 for responsively generating a usability-adapted derived output using a structured prompt framework, in accordance with an exemplary embodiment of the present invention. The method 800 comprises the steps of: a) receiving 802, via an input interface, user signals, behavioral indicators, sensor data, data originating from learning/education platforms, contextual data, or service-provider data originating from an online or offline environment; b) transforming 804, the received unstructured or semi-structured data into a standardized intermediate format using a schema transformation engine that performs pattern recognition, schema inference, format translation, or prompt-based conversion through one or more large language models (LLMs) or AI agents; c) generating and responsively updating 806, a usability profile for the user; d) applying 808, by one or more processors, a prompt framework to select and configure LLMs or AI agents based on the standardized intermediate format, the usability profile, and environmental context, the prompt framework directing ordered stages comprising interpretation of the normalized data, selection of prompt-engineering techniques, and generation of structured intermediate reasoning outputs; e) evaluating 810, the structured intermediate reasoning outputs against metadata contained in an usability profile, including cognitive load, sensory access, language access, interaction history, historical signals or usage patterns or situational context, to confirm alignment with user needs and interaction constraints; and f) producing 812, via an output interface, a derived output tailored to the usability profile. The derived output comprises at least one of text simplification, language translation, alternative modalities including voice or haptic interfaces, modular content presentation, or markup customized to the usability profile.

In step d), the one or more processors apply the prompt framework that dynamically selects prompt-engineering techniques, including chain-of-thought prompting, few-shot prompting, retrieval-augmented generation, or parameter-efficient adaptation, based on profile attributes. The usability profile attributes include at least one of the following: reading speed, assistive technology use, ambient noise, lighting conditions, device type, or historical interaction outcomes.

In step d), applying 808, the prompt framework also includes generating structured intermediate reasoning objects that record parsed entities, contextual cues, environmental indicators, usability-profile parameters, and preliminary transformation steps. These objects are stored to refine the usability profile and guide subsequent stages of the prompt framework.

The prompt framework includes a verification stage that incorporates responsive-loop signals derived from real-time behavioral feedback, sensor inputs, or environmental context to validate the suitability of selected models, prompt techniques, or modality decisions, and to adjust subsequent reasoning steps when observed interaction patterns indicate a need for modification. Moreover, the prompt framework incorporates universal design guidelines and domain-specific usability standards as constraints applied during model selection, prompt construction, and reasoning stages, thereby regulating simplification thresholds, modality selection, and content structuring to ensure consistency with the user's cognitive, sensory, motor, or language access needs.

The usability profile includes deriving one or more parameters from behavioral indicators, environmental context, declared preferences, sensor data, or historical usage patterns. This enables enhanced personalization, improved predictive accuracy, and optimized user experience.

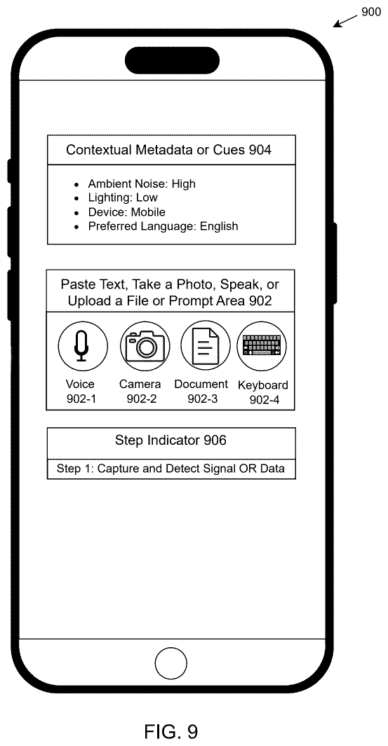

FIG. 9 illustrates an exemplary user interface 900 displayed on a computing device for initiating an interaction and capturing multimodal user signals, contextual information, and service-provider data, in accordance with an embodiment of the present invention. The computing device includes, but is not limited to, a smartphone, tablet, kiosk, or a wearable device. The user interface 900 enables the user to submit information or prompts in multiple formats, including text input, voice input, camera-based capture of printed or on-screen content, or uploading of digital files. A prompt area 902 comprises one or more icons 902-1-902-4 that represent alternative input modalities (microphone, camera, document upload, and keyboard) to enable the user to submit information or prompts in multiple formats. Further, the user interface 900 dynamically displays system-detected contextual metadata or cues 904 such as ambient noise, lighting level, device type, or preexisting language preferences derived from the usability profile. The prompt area 902 of the user interface 900 guides the user to initiate the interaction, and a step indicator 906 indicates that the computing device or system is performing Step 1: Capture and Detect Signal or Data. Signal or data is collected at this stage, including service-provider data, behavioral indicators, contextual information, environmental context, and multimodal user inputs or signals, and is forwarded to the schema transformation engine for normalization and downstream reasoning.

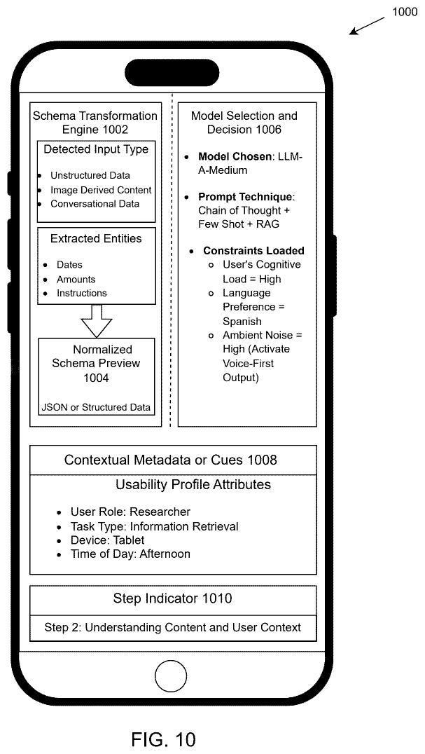

FIG. 10 illustrates an exemplary user interface 1000 showing a schema transformation engine and a model selection and decision pane applied to the user input, in accordance with an embodiment of the present invention. The user interface 1000 visualizes the transformation of the user's captured input into a standardized intermediate format (normalized schema preview), and applies a prompt framework to select appropriate AI models, prompting techniques, and adaptation strategies. A schema transformation engine 1002 displays the detected input type (for example, unstructured text, image-derived content, or conversational data) and a normalized schema preview or structured representation 1004 of extracted entities generated by the schema transformation engine 1002. A model selection and decision pane 1006 indicates system-selected components including an LLM configuration, prompt technique (for example, chain-of-thought prompting, few-shot prompting, or retrieval-augmented prompting), and profile-based constraints (for example, language preference, cognitive load indicators, or environmental conditions (ambient noise). Contextual metadata or cues 1008 display relevant usability-profile attributes (user role, task type, device, or time of day) to guide model routing decisions. A step indicator 1010 denotes Step 2: Understanding Content and User Context. FIG. 10 demonstrates the system's or computing device's ability to apply structured prompt framework logic in response to the user's profile and contextual environment.

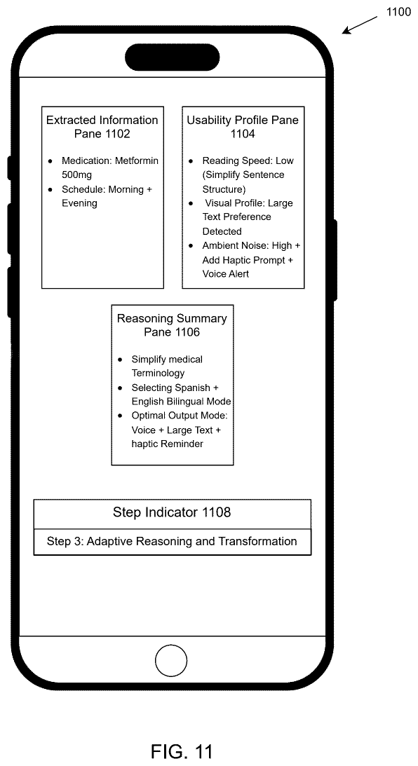

FIG. 11 illustrates an exemplary user interface 1100 displaying intermediate reasoning outputs generated by the system or the computing device during adaptive transformation of the standardized input, in accordance with an embodiment of the present invention. The user interface 1100 presents intermediate reasoning, depicting structured outputs generated by one or more AI agents or LLMs operating within the model selection and decision process (as explained in FIG. 10). An extracted-information pane 1102 shows key elements (e.g., medication or schedule) identified from the standardized input. A usability-profile pane 1104 displays active profile attributes influencing adaptation decisions, including reading-speed indicators, detected visual-access preferences, or profile, environmental, or ambient noise conditions. A reasoning-summary pane 1106 provides a human-interpretable representation of preliminary transformation logic, including simplification steps, modality selection, and language adjustments determined by the model selection and decision. The user interface 1100 also includes a step indicator 1108 showing Step 3: Adaptive Reasoning and Transformation. The structured intermediate reasoning output is stored as an internal record used to refine the usability profile and guide subsequent operations.

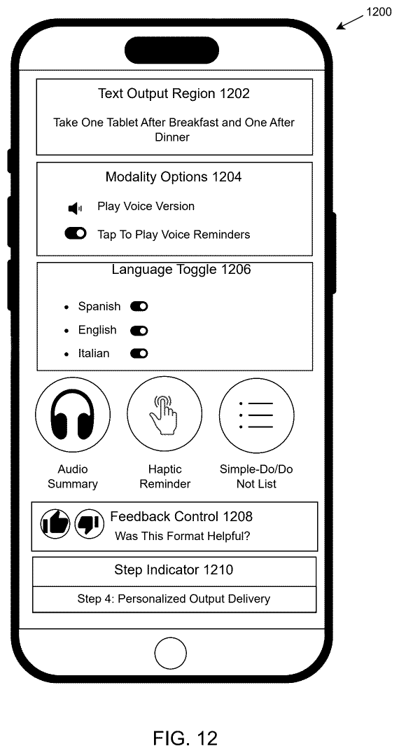

FIG. 12 illustrates an exemplary user interface 1200 presenting a personalized, multimodal derived output generated according to the evolving usability profile, in accordance with an embodiment of the present invention. The user interface 1200 presents a personalized, accessibility-adapted output derived from the system's or a computing device transformation pipeline. A text output region 1202 displays simplified or translated content formatted according to the user's cognitive, sensory, and language access needs. A set of modality options 1204 allows users to activate voice playback, haptic feedback, or alternative structured presentations. A language toggle 1206 enables switching among supported languages or dialects inferred or declared within the usability profile. Feedback control 1208 solicits user confirmation of the usefulness of the generated output, and the response is incorporated into the feedback loop to update the usability profile. A step indicator 1210 displays Step 4: Personalized Output Delivery. FIG. 12 demonstrates how the system or the computing device presents a multimodal result adapted to the user's real-time usability state, environmental context, and profile.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described. A function or an act should be interpreted as incorporating all modes of performing the function or act unless otherwise explicitly stated.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art that although the preferred and alternate embodiments have been shown and described in accordance with the Patent Statutes, the invention is not limited thereto or thereby.

The terminology used herein is for the purpose of describing particular embodiments only and is not intended to be limiting to the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention and some of its advantages have been described in detail for some embodiments. It should also be understood that various changes, substitutions, and alterations can be made herein without departing from the spirit and scope of the invention as defined by the appended claims. An embodiment of the invention may achieve multiple objectives, but not every embodiment falling within the scope of the attached claims will achieve every objective.

1. A system for optimizing usability for a user across a range of usability needs comprising:
an input interface for capturing at least one of user signals, behavioral indicators, sensor data, data originating from learning/education platforms, or service provider data from an online or offline environment;
a processor to deploy a schema transformation engine using one or more artificial intelligence (AI) agents or large language models (LLMs) for the transformation of the captured unstructured or semi-structured data to structured data based on a schema to provide a standardized format suitable for downstream processing, and to generate a usability profile;
a storage to maintain and update the usability profile and metadata; and
an output interface for presenting a derived output.

2. The system according to claim 1, wherein the input interface captures behavioral and contextual data.

3. The system according to claim 1, wherein the schema transformation engine includes at least one of pattern recognition, schema inference, format translation, or a prompt-based conversation using LLMs or AI agents, enabling interoperability across data sources.

4. The system according to claim 1, wherein the output interface presents the derived output as a training dataset to one or more artificial intelligence (AI) systems.

5. The system according to claim 1, wherein the output interface presents the derived output as an inference dataset to one or more artificial intelligence (AI) systems.

6. The system according to claim 1, wherein the schema transformation engine detects, parses, and transforms the captured unstructured or semi-structured data into standardized intermediate formats suitable for AI-powered processing and usability adaptation.

7. The system according to claim 1, wherein the metadata comprises at least one of cognitive load, sensory access, language access, preferences, interaction history, real-time feedback, sensor inputs, historical usage patterns, environmental context, situational adaptation history, or other interaction parameters.

8. The system according to claim 1, wherein the usability profile includes one or more parameters derived from at least one of behavioral indicators, environmental context, declared preferences, sensor data, or historical usage patterns.

9. The system according to claim 1, wherein the processor deploys the one or more artificial intelligence (AI) agents or large language models (LLMs) to apply techniques selected from at least one of prompt engineering, chain-of-thought prompting, few-shot learning, retrieval-augmented generation (RAG), parameter-efficient fine-tuning (PEFT), low-rank adaptation (LoRA), or reinforcement learning from human feedback (RLHF) to reason over the standardized format and generate transformations tailored to the usability profile and universal design guidelines.

10. The system according to claim 1, wherein the output interface employs an output personalization engine to generate the derived output.

11. The system according to claim 1, wherein the derived output includes at least one of text simplification, language translation, alternative modalities including voice or haptic interfaces, modular content presentation, markup customized per the usability profile, or any other service customized based on the usability profile.

12. The system according to claim 1, wherein the system is at least one of a smartphone, an electronic device, a tablet, a kiosk, a laptop, a wearable, a voice assistant, or an embedded system.

13. A method for optimizing usability for a user across a range of usability needs, comprising:
capturing at least one of user signals, behavioral indicators, sensor data, data originating from learning/education platforms, or service provider data from an online or offline environment;
transforming the captured unstructured or semi-structured data into standardized formats based on a schema suitable for downstream processing;
generating a usability profile for the user;
maintaining and responsively updating the usability profile and metadata; and
presenting a derived output using the standardized format.

14. The method according to claim 13, wherein the method further comprises capturing behavioral and contextual data.

15. The method according to claim 13, wherein transforming the captured unstructured or semi-structured data includes performing at least one of pattern recognition, schema inference, format translation, or a prompt-based conversation using large language models (LLMs) or AI agents to enable interoperability across data sources.

16. The method according to claim 13, wherein the method comprises presenting the derived output as a training dataset to one or more artificial intelligence (AI) systems.

17. The method according to claim 13, wherein the method comprises presenting the derived output as an inference dataset to one or more artificial intelligence (AI) systems.

18. The method according to claim 13, wherein transforming the captured unstructured or semi-structured data comprises detecting, parsing, and transforming the data into standardized intermediate formats suitable for AI-powered processing and usability adaptation.

19. The method according to claim 13, wherein the usability profile includes deriving one or more parameters from at least one of behavioral indicators, environmental context, declared preferences, sensor data, or historical usage patterns.

20. A computer-implemented method for generating a usability-adapted derived output using a structured prompt framework, comprising:
receiving, via an input interface, at least one of user signals, behavioral indicators, sensor data, data originating from learning/education platforms, contextual data, or service-provider data originating from an online or offline environment;
transforming the received unstructured or semi-structured data into a standardized intermediate format using a schema transformation engine that performs at least one of pattern recognition, schema inference, format translation, or prompt-based conversion through one or more large language models (LLMs) or AI agents;
generating and updating a usability profile for the user;
applying, by one or more processors, a prompt framework to select and configure LLMs or AI agents based on at least one of the standardized intermediate format, the usability profile, or environmental context, the prompt framework directing ordered stages comprising at least one of the interpretation of the normalized data, selection of prompt-engineering techniques, and generation of structured intermediate reasoning outputs;
evaluating the structured intermediate reasoning outputs against metadata contained in the usability profile, including at least one of cognitive load, sensory access, language access, interaction history, historical signals, usage patterns, or situational context, to confirm alignment with user needs and interaction constraints; and
producing, via an output interface, a derived output tailored to the usability profile, the derived output comprising at least one of text simplification, language translation, alternative modalities including voice or haptic interfaces, modular content presentation, or markup customized according to the usability profile.

21. The method according to claim 20, wherein the prompt framework dynamically selects prompt-engineering techniques, comprising at least one of chain-of-thought prompting, few-shot prompting, retrieval-augmented generation, or parameter-efficient adaptation, based on usability profile attributes such as reading speed, assistive-technology usage, ambient noise, lighting conditions, device type, or historical interaction outcomes.

22. The method according to claim 20, wherein applying the prompt framework further comprises generating structured intermediate reasoning objects that record at least one of parsed entities, contextual cues, environmental indicators, usability-profile parameters, and preliminary transformation steps, the objects being stored for use in refining the usability profile and informing subsequent prompt-framework stages.

23. The method according to claim 20, wherein the prompt framework includes a verification stage that incorporates responsive-loop signals derived from at least one of real-time behavioral feedback, sensor inputs, or environmental context to validate the suitability of selected models, prompt techniques, or modality decisions, and to adjust subsequent reasoning steps when observed interaction patterns indicate a need for modification.

24. The method according to claim 20, wherein the prompt framework incorporates universal-design guidelines and domain-specific usability standards as constraints applied during at least one of model selection, prompt construction, and reasoning stages, thereby regulating simplification thresholds, modality selection, and content structuring to ensure consistency with the user's cognitive, sensory, motor, or language-access needs.

25. The method according to claim 20, wherein the usability profile includes deriving one or more parameters from at least one of behavioral indicators, environmental context, declared preferences, sensor data, or historical usage patterns.
